(19) United States
(12) Patent Application Publication
(10) Pub. No.: US 2011/0216006 A1
(43) Pub. Date: Sep. 8, 2011

(54) Method for inputting data

(75) Inventor: Dietmar Litschel, Klosterneuburg (AT)

(73) Assignee: CARETEC GMBH

(21) Appl. No.: 12/998,551

(22) PCT Filed: Oct. 30, 2009
(86) PCT No.: PCT/EP2009/064364

§ 371 Date: May 2, 2011

(30) Foreign Application Priority Data
Oct. 30, 2008 (AT) A1693/2008

(51) Int. Cl. G06F 3/02

(52) U.S. Cl. 345/168

(57) ABSTRACT

The invention relates to a method for inputting data through a keyboard to whose keys individual characters of a character set are assigned, wherein the number of keys is less than the number of characters of the character set and wherein the character set preferably contains punctuation marks. An improvement in operability is accomplished in that sequences of key strokes corresponding to sequences of characters which are impossible or improbable in the context of the data to be input are used for encoding characters or character sequences that are not assigned to a key.

The present invention relates to a method for inputting data through a keyboard to whose keys individual characters of a character set are assigned, wherein the number of keys is less than the number of characters of the character set and wherein the character set preferably contains punctuation marks.

Typing has the advantage compared with handwriting that it is less strenuous and the typed text can easily be supplemented, corrected, stored, and can be output electronically, visually, acoustically and in a tactile manner and received in an identifiable manner. Input is particularly efficient if it is accomplished by “touch typing”, i.e. without eye contact with the keys. Many people make use of typing using the PC but there are still very many more people who can only use this partially or not at all. Apart from the fact that the PC has not yet reached the threshold of size reduction to give an efficient “pocket-size” device which can be used by anyone as a mobile device, although the technical conditions for this exist.

People of all ages are affected by the disadvantage of poor access to typing. However, this particularly applies to elderly people having poor health and difficulties in writing longhand. It also applies to people having motor problems for whom it is important to be able to generate as much text as possible with as few strokes as possible to minimise physical effort. In addition it applies to speech-impaired persons (deaf mutes etc.) for whom fast typing is important to be able to rapidly communicate that which is written to other people by synthesized voice. People who can only use one hand also have the requirement to be able to write efficiently. This equally applies to blind people who wish to check the text, written using one hand, on a tactile display with the other hand. Blind people also have an additional problem since 92% to 93% of them cannot read the blind script Braille. This is because most blindness occurs at an advanced age and also because of the difficulty of learning and reading the script itself so that there is a latent need for a simpler blind script.

According to the invention, it is provided that sequences of key strokes corresponding to sequences of characters which are impossible or improbable in the context of the data to be input, are used for encoding characters or character sequences that are not assigned to a key.

In German-language texts, for example, character combinations such as “,a”, “,b” etc (usually a comma is followed by a space or a numeral), “qa”, “qb” etc. do not occur. These and similar combinations are therefore available for encoding characters or character strings which cannot be directly addressed by individual keys or chord strokes of keys.

An essential difference from the usual text input via numeric keypads, such as is used for example in mobile telephones for sending messages, can therefore be seen in that after a key combination there is no need to maintain a pause to give the device the opportunity to distinguish between the encoding of individual characters or combination codes. For example, the letter “B” is encoded by the combination of keys “A” followed by “A”. The device can in this case only distinguish the desired input of “B” from the desired input of “AA” by the length of the time interval between the key depressions, which severely limits the input speed.

In a similar application of the above inventive idea, the invention also relates to a method for outputting data via a display, a printout or via temporary stimuli, through symbols which are assigned to individual characters of a character set, wherein the number of symbols is less than the number of characters of the character set and wherein the character set preferably contains punctuation marks.

For example, a device in the manner of a known Braille line in which retractable pins are provided to represent the dots can be considered as a display here. A printout is carrier material such as paper that is provided with punctuate elevations. Temporary stimuli in the above sense designate a type of output in which pressure or other tactilely detectable stimuli are exerted on skin regions of the user in time sequence to represent characters, it is therefore not necessary for the user to actively touch a reading zone.

According to the invention it is provided that sequences of symbols corresponding to sequences of characters which are impossible or improbable in the context of the data to be input, are used for encoding characters or character sequences that are not assigned to a symbol.

Output symbols which are meant in this context are characters, for example, in the manner of Braille characters. The usual Braille script with six dots, which only allows a limited character set, is difficult to learn for many people such as those who have gone blind in later life. This applies even more so to the extended Braille script with eight dots. The basic idea of the invention is now applied to the output since the number of symbols used is limited. This can mean that the concept of a 6-dot Braille script is retained but easily confused symbols are omitted. This can, however, also mean that a type of 4-dot Braille script with a correspondingly reduced supply of symbols is used. In the same way as in text input, a larger character set is imaged onto a small number of keys, the character set in the output is imaged onto a small number of symbols. Naturally, in the sense of easy perceptibility it is absolutely advantageous if the two images are identical. If a certain character such as “Ä” is now encoded by the key combination “,ae” in the input, the symbol sequence “,ae” will also be output in the output to represent this character.

The invention further relates to a method for outputting data in the manner described above in which characters are represented by excitation of various skin regions of the user and in which a plurality of excitation modes which are used alternately are assigned to each skin region.

It has been found that in any type of representation of Braille script a major problem is the fatigue of the skin areas of the user with which the tactile stimuli are perceived. If, for example a Braille script or a similar code is now communicated by representing individual dots by stimulating the fingertips of different fingers of the user, this can take place according to known systems by applying a mechanical pressure or an electrical or mechanical vibration to the relevant skin region of the finger or not. As described above, such a method is restricted by fatigue effects. According to the invention the excitation mode is now varied in time sequence by dividing, for example, the skin region for a specific dot spatially into sub-regions or excitation points. By regular or randomly controlled variation of the addressed excitation points, fatigue can be prevented. Usually all the excitation points and therefore all excitation modes are synonymous in terms of information content.

In practice, such an output can be executed as follows, for example. The five fingers of the hand of a user are inserted into corresponding receiving openings so that the fingertips lie opposite excitation devices each consisting of ten retractable needles. The projection of a needle, which is perceived by the relevant fingertip, corresponds to the output of a dot in a 5-dot code with which 32 characters can be represented directly. If the first finger is now to be excited to represent a character, the needles 1 and 8 in the corresponding receiving opening are randomly activated. If this finger is to be excited again subsequently to represent one of the next characters, needles 2, 3 and 10 are addressed, which corresponds to an alternative excitation mode. This stimulus thereby differs in intensity and location from the preceding one, which counteracts fatigue. Similarly distinctions can be made in regard to the vibration frequency or the like.

It is not absolutely essential in the sense of the invention that the different excitation modes described above are always synonymous. Optionally the user can be informed by the excitation mode whether a certain character combination comprises a code for an individual character or an abbreviation code to represent an entire word or text section.

Important aspects of the invention are described in detail hereinafter.

(1) Text Inputs: Prior Art

(A) FULL KEYBOARDS: The typewriter keyboard (PC keyboard, full keyboard, QWERTZ keyboard) provides all the characters of the current character set of the respective language ready for hitting. Input is made in single or shifted stroke. The characters can be typed on the keyboard with both hands and without eye contact to the keys (blind). This “touch typing” is however, frequently not mastered so that the typing efficiency on average is low. The keyboard forms a unit with the computer, monitor and printer, which provides internet access and can be networked with other units. The PC keyboard is also used in laptops and in very small versions on which touch typing is not possible as a result of the smallness of the keys. For speech-impaired people mobile communication devices with speech output, LCD display and strip printers are supplied, whose keys are arranged in alphabetical order.

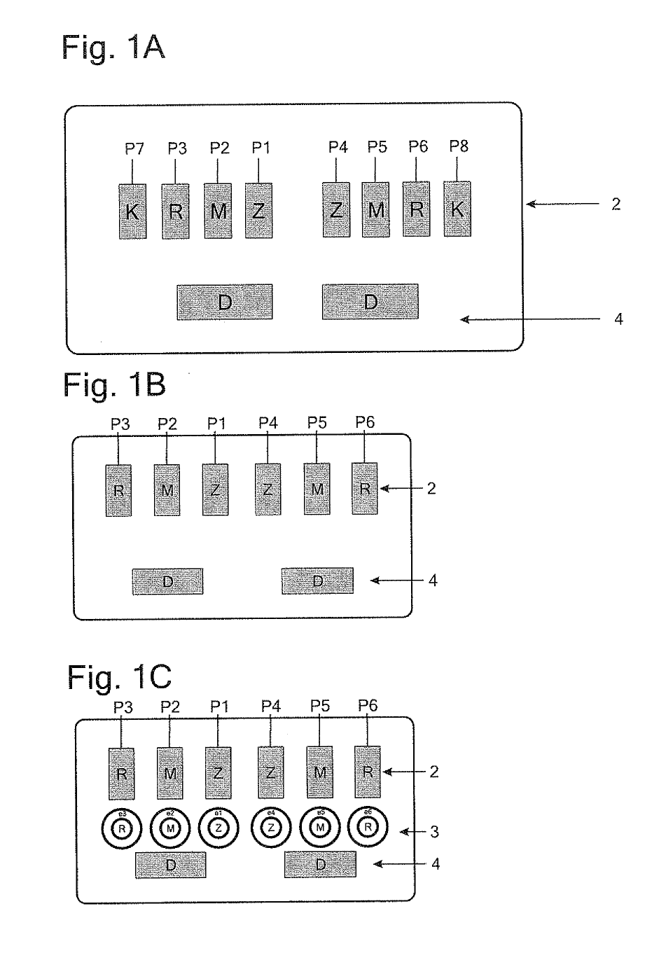

(B) CHORD KEYBOARDS: on these several keys can be hit simultaneously. Braille keyboards having 8 keys (FIG. 1A) and also having 6 keys (FIG. 1B) are used in the blind area. Due to the chord stroke, fewer keys are required so that the keyboard can be designed smaller. Chord strokes require the mastering of touch typing.

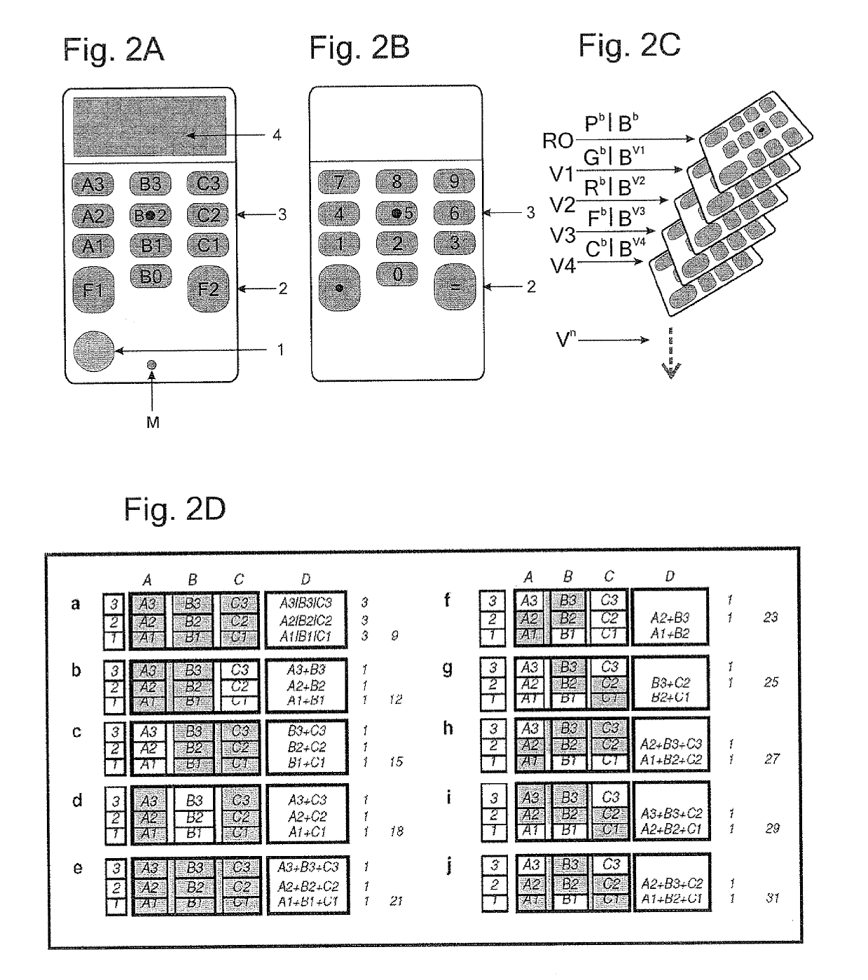

(C) ONE-HANDED AND THUMB KEYBOARDS: in these the ten-key keypad (FIG. 2B) is extremely important for inputting digits whereas the typing of texts is not meaningful on account of the large number of keys and the limited number of fingers. The mobile phone solves this problem with multiple stroke of the keys. However, this mode is not efficient. However, the mobile phone has the advantage that the input can be made with the thumb of one hand. It requires no storage area and can be used in almost all life situations.

(D) MACHINE STENOGRAPHY KEYBOARDS: in some countries machine-stenography systems with special chord keyboards are used. On these syllables and word abbreviations are input and converted into the target words in a second operation. The input on these keyboards is difficult to master because it necessitates the mastering of a comprehensive abbreviation system and the key strokes impose high requirements on the finger readiness of the user.

(2) New Type of Method for Machine Text Input

Many seeing people read frequently but write little. Since the mobile phone SMS, more is being written which reveals the persistent need for written texts and also the preference for typing. However, efficient typing requires knowledge which many people do not have. Our invention provides a new type of generally accessible machine text input.

2.1 The Basic Concept

(A) CHARACTER SETS: we determine the size of our character sets not by the number of characters to be used but by the physiological and intellectual capacities of the person: firstly, according to the number of keys which can ergonomically advantageously be hit with one hand on short finger paths and secondly according to the capacity of the person to learn and maintain efficient touch typing on the keys with least possible effort. The former eliminates the use of the thumb and the little finger since these cannot be used sufficiently efficiently for the key stroke, the latter eliminates the strokes for the rarely used characters since the effort for learning these strokes is not worthwhile because of the low usage, especially as the knowledge of these is also lost the soonest.

As a result of the preference of the three middle fingers, we see the ideal of our one-handed keyboard in the ten-key keypad. On its nine central character keys 31 strokes can be executed ergonomically advantageously (FIG. 2D). They are not sufficient for the 98 common characters of the German language so that many substitute or alternative strokes are required. This seems disadvantageous but is not since, according to German language statistics [Helmut Meier, 1978], the 24 most frequent characters cover 99.1% of all texts. In the interests of simple touch typing, preference should therefore be given to small character sets whereas for experienced typists somewhat larger ones can be selected provided that no efficient substitute inputs lend themselves as equally advantageous.

(B) SUBSTITUTE INPUTS: since strokes are only available for the most frequently used primary characters, the substitute inputs can only be typed with these. They are extended, shortened, corrected or converted in some other way during the input. Substitute inputs are used for retrieving information, for executing text processing functions and for operating the keyboard and the (multimedia) apparatus (internet, telephone, GPS etc.) connected to it.

(C) ALTERNATIVE INPUTS: with these, characters located on conceptually subordinate virtual keyboard levels can be input “directly” with the same efficiency as the characters on the real upper keyboard level. According to the invention, the input takes place on the (wrong) “real” keyboard level. During the subsequent post-stroke on the designated key, the input is converted “on the fly” as though the input had taken place on the correct keyboard level.

(D) ACOUSTIC INPUTS supplement the textual inputs. They are recorded with recorders and converted into written text with speech recognition. With these auxiliary functions for renewing knowledge about key strokes and any other information can be retrieved and text processing and keyboard operating functions can be executed.

(E) BLOCK STRUCTURE: Our one-handed keyboard has a virtual three-dimensional block structure (FIG. 2C) which helps to minimise the number of keys.

E1: REAL UPPER KEYBOARD LEVEL [RO]: the primary character block and the control block are located on this level (FIG. 2A). The primary lower case letters and the primary punctuation marks such as the comma, for example, [,] are input on the primary character block [P^{b}] (B0 to C3) The keys of the control block [B^{b}] (F1 and F2) can be used as required for inputting primary characters and those of the primary character block can also be used for inputting control functions.

E2: VIRTUAL KEYBOARD LEVELS (FIG. 2C): the control blocks of the virtual keyboard levels [B^{v1}] [B^{v2}] [B^{v3}] [B^{v4}] are located conceptually below the control block [B^{b}]. They support their virtual levels. When they are not required, they are also available to the control block [B^{b}]. Located conceptually below the primary character block [P^{b}] is the upper case block [G^{b}], the computing block [R^{b}], function block [F^{b}], cursor block [C^{b}] and some others. The characters located on the blocks can be retrieved “on the fly” (see alternative strokes), temporarily or permanently on the upper keyboard level such as for example, the upper case block [G^{b}] for permanent upper case typing or the computing block [R^{b}] for executing computing operations.

2.1 Primary Character Sets

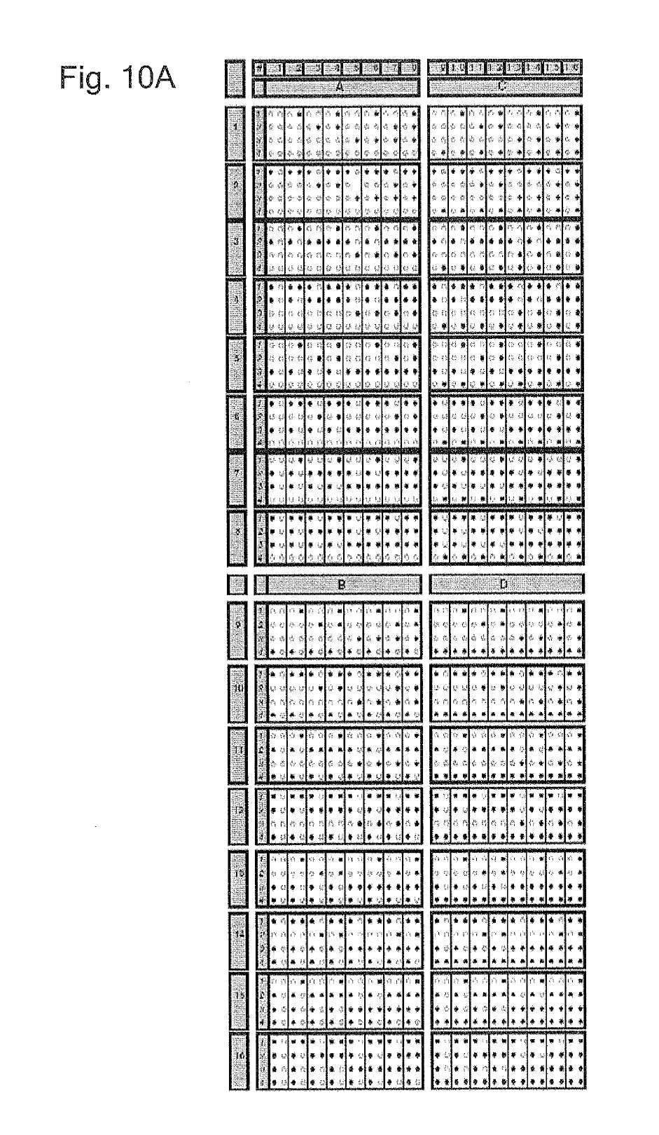

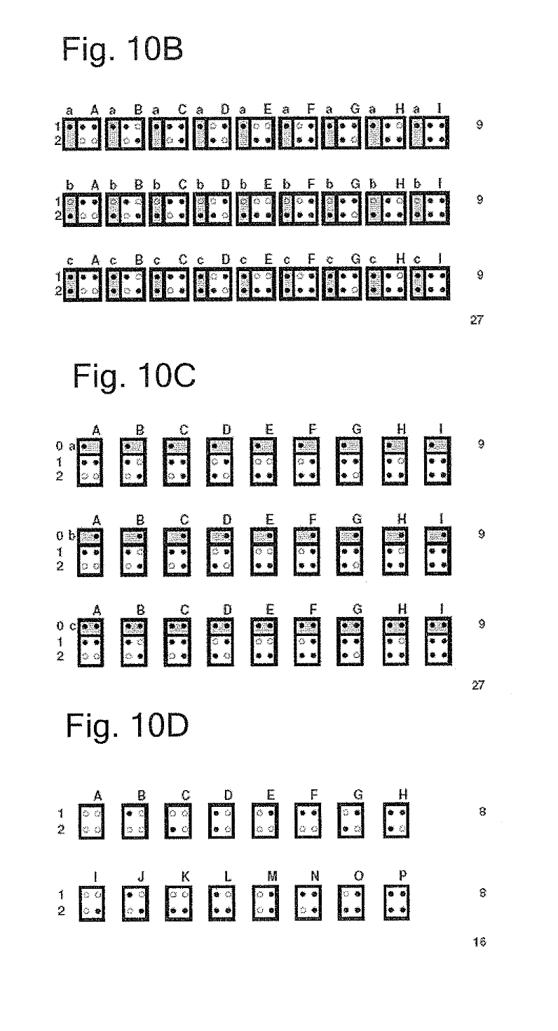

(A) PRIMARY CHARACTER SET WITH 16 PRIMARY CHARACTERS: a particularly small character set consists of 16 primary characters. This accommodates people who can only use a few fingers for typing and also blind people who have difficulties in learning the blind script Braille. This is insofar as the 16 tactile characters (elevated dots) can be represented on an (ideal) matrix of only 2 columns and 2 rows (FIG. 10D). The restriction to so few characters makes input difficult however since use must be made of various ad-hoc solutions.

(B) PRIMARY CHARACTER SET WITH 23-26 PRIMARY CHARACTERS: The primary character sets should ideally consist of 23 to 26 characters, wherein 23 characters already cover 98.6% of all texts.

2.3 Direct Input Modes

(A) PRIMARY CHARACTERS: along with the most important lower case letters, the comma [,] is also provided as a primary character.

(B) SECONDARY CHARACTERS: the umlauts [ä,ö,ü] and the [β] can be written [ae,oe,ue,sz] and left so since this notation is generally known. However, an autocorrection can be provided for frequent words. Examples: [aelter=älter] [oefter=öfter] [grosz=groβ].

Further simplification: the full stop can be written with a double stroke of the comma [,,=.] and the corresponding upper case letter can be written with a double stroke of a lower case letter at the beginning of a word [aadler=Adler]. The characters [qu,x,y] can be written with [kwe], [iks] and [ips] and converted with autocorrection.

(C) INPUTS ON THE COMPUTING BLOCK: located on the computing block [R^{b}] are the numbers [0-9] and also some operands [,][+][-][*][/][=][%], which correspond to punctuation marks and special characters. These characters and also any other punctuation marks or special characters such as [:][.] can also be input as alternative inputs (see Point 2.1C). That is, they are wrongly input on the lower case block [K^{b}] and are converted by subsequently selecting the computing block [^{tr}]. The date and the clock time can also be written in this way: [a^{tr}=1][dgaa^{tr}=4711]; [,=,][+=+][-=-][*=*]; [d.g.bjji^{tr}=4.7.2009][aj:de^{tr}=10:45 hours].

(D) UPPER CASE LETTERS can also be typed wrongly with lower case letters and converted by subsequently selecting the upper case block [^{tg}]: [a^{tg}dler=Adler] [adler^{tg}=ADLER].

2.4 Indirect Input Modes

(A) INPUT PRINCIPLE: the substitute inputs can be written in various ways, where they should have reference to the target input in order to make access to the text input as simple as possible for the users. For example, the substitute input for [?] can be the word [Fragezeichen] or a mnemonic abbreviation such as [frage, frz, or fr]. If a secondary character is required for a substitute input such as, for example, a [ü] for [fünf] the substitute input can be written incorrectly such as [fuenf] or as [finf].

The variants specified a priori with which the substitute inputs “may” be written are stored with their common target input in a comprehensive file. If a written variant agrees with a specified variant, the target input goes into the respective input file. The specified variants of the substitute input must be unmistakeable which necessitates a corresponding identification. In the identification a distinction should be made between natural and artificial.

(B) Identifications of Inputs

B1: NATURAL IDENTIFIERS are particular features of the script. They enable an automated typing support. For example, nouns can be identified by their word ends [haftung=Haftung, trennung=Trennung], and also certain punctuation marks [full stop, comma, exclamation mark] by a space and a full stop is usually followed by an upper case letter.

B2: ARTIFICIAL IDENTIFIERS, hereinafter designated as [eee] are set by users during the writing process. The identifiers [^{k}] can be an integrated part of the substitute input [^{k}eee, eee^{k}, e^{k}ee] or stand-alone [^{k}_eee]. A substitute input can comprise one or more identifiers of the same or different type [^{k}ee^{k}e] [^{k2k1}eee]. The identifiers can be formed from lower case letters [^{b}], numeric codes [^{nc}], alphanumeric codes [^{ac}], as well as punctuation marks and special characters [^{s}]. Identifications can also take place by strokes on non-character keys [^{tn}].

B3: FREQUENT LETTERS only come into consideration as identifiers if they are represented in such a way that they are never normally encountered, for example, as [c,j,w] at the end of a word or as [βfβczz].

B4: RARE LETTERS such as [q,x,y] are particularly well suited as identifiers. Particularly if the identifier is unmistakable.

B5: PUNCTUATION MARKS: the comma is suitable as an identifier in those places at which it is not normally used such as [_,eee][e,ee][eee,z]. Other punctuation marks are also very suitable if they occur rarely.

(C) CONVERSION EXAMPLES: the following identifications are examples which can be replaced by any others:

C1: SECONDARY CHARACTERS: [^{x}a=ä] [,a=ä] [tr^{x}age=träge]

Automatic conversions: [ae=ä]

C2: UPPER CASE LETTERS:

Examples: [grossa^{x}=A] [grossaalle^{x}=ADLER] [^{t1}adler=Adler] [^{t1}ad^{t1}ler=ADler]

Alternative: [aadler=Adler] [a^{tg}dler=Adler] [adler^{tg}=ADLER]

Selecting the upper case block: permanent upper case typing

C3: DIGITS AND NUMBERS:

[eins^{x}=1] [siebenundvierzigelf^{x}=4711],

Alternative: [a^{tr}=1] [dgaa^{tr}=4711] [d.g.bjji^{tr}=4.7.2009] [aj:de^{tr}=10:45 hours].

C4: PUNCTUATION MARKS AND SPECIAL CHARACTERS: [,=,][,,=.] [fagezeichen^{x}=?] [fage^{x}=?]

[frz=?] [fr^{x}=?] [paragraph^{x}=§] [para^{x}=§] [pa^{x}=§] [omega^{x}=Ω] [usdollar^{x}=$]

Alternative: [+=+] [-=-] [*=*] [/=/] [===]

(D) COMPLETION OF TEXT INPUTS:

D1: WORDS: words and texts which are input as short text, acronyms, code, SMS or mnemonic abbreviations can be converted with conversion programs or word corrections, the conversion following an automatic space. Examples:

[d_=die] [r_=der] [u_=und] [t_=nicht]

[ndw^{x}=nichtsdestoweniger] [aspa^{x}=so bald wie möglich]

[at^{x}=Österreich] [oe^{x}=Österreich] [oei^{x}=Österreichisch]

[de^{x}=Deutschland] [der^{x}=deutscher] [it^{x}=Italien]

[ddsg^{x}=Donaudampfschifffahrtsgesellschaft]

D2: PREFIXES AND SUFFIXES:

[fstehen=aufstehen] [sgeben=ausgeben] [tgleiten=entgleiten]

[ggwart=Gegenwart] [gemeinht=Gemeinheit]

[tapferkt=Tapferkeit] [rechng=Rechnung] [gemeinft=Gemeinschaft]

(E) WORD CORRECTIONS: the written and completed words are run through a spell check of the file. This contains a large number of correctly written, in particular rare and foreign words. These are compared with frequent misspellings. If such a misspelling is detected, the misspelling is replaced by the correct spelling: [Ritmus=Rhythmus].

(F) INFORMATION RETRIEVAL: standard texts, text modules, addresses, telephone numbers etc. can be retrieved with keywords (identifiers). Example: [hohlegasse^{x}=Durch diese hohle Gasse muss er kommen, es führt kein andrer Weg nach Küssnacht].

(G) TEXT PROCESSING FUNCTIONS: editing functions are carried out with key strokes. These are efficient but not always user-friendly. They frequently interrupt the typing flow and thereby reduce the typing speed. Particularly when using the computer mouse.

In order to facilitate the editing of texts and minimise interruptions, acoustic and textual editing functions are provided which can be mutually supplemented. Example of a text change in which the existing text “Wir liefern Ihnen die Produkte am nächsten Montag” is to be changed: (a) acoustic or textual input of the identified command and the initial and end word of the sentence [ersetze^{x} Wir Montag]; (b) after retrieving the sentence this is acoustically or textually replaced with the new text: [Wir danken für Ihren Auftrag, den wir am nächsten Monatag ausliefern werden].

According to this principle, the other editing functions such as search, copy, cut, insert (and the like), the functions of the function strip (PC) and the parameter settings of the screen icons (PC) can be retrieved “directly” by inputting the word of the function, with mnemonic abbreviations or the same or encoded (acoustic or textual).

(H) CONTROL FUNCTIONS: the control of keyboards and simple and multimedia units connected to them such as internet, telephone, GPS and the like is usually accomplished with key strokes. The plurality of functions makes control difficult and impairs the user friendliness of the respective text detection unit. Our keyboard provides acoustic and textual control commands during operation of the keyboard with which the respective functions can be retrieved directly.

(3) New Types of Text Input Apparatus

3.1 ONE-HANDED KEYBOARD: In this (FIG. 2A) thumb and little finger are provided for holding the keyboard during the typing process. The three middle fingers are located on keys 4-5-6 in the base position from where the strokes can be made with short finger paths avoiding spreading movements.

The real upper keyboard level [RO] of the one-handed keyboard consists of the primary character block [P^{b}] (B0 to C3), which consists of 10 character keys and the control block [B^{b}] with the keys FIG. 1 and FIG. 2. The control keys can be used for typing the primary characters (as explained) and the primary characters can also be used for executing control functions.

On the real upper keyboard level [RO] the strokes of all the virtual keyboard blocks located conceptually thereunder are executed which for this purpose are retrieved permanently, temporarily or on the fly on the real keyboard level. Permanent selection is provided for inputting upper case letters [G^{b}] which are written with the corresponding lower case letters. During permanent selection of the computing block [R^{b}] this is used as a pocket computer. Temporary selection for inputting individual characters is accomplished by pre-strokes of designated non-character keys whilst the misentries made on the upper keyboard level are “on the fly” corrected with post-strokes on designated keys (see Point 2.1C).

FIG. 2B shows the computing block [R^{b}] on which the digits and numbers, the comma (or the full stop) on the F1 key and the equals sign [=] are input on the F2 key with a single stroke. Also located on the computing block are the stroke positions of the operands [,][+][-][*][/] [=][%] and any other punctuation marks and special characters such as [:][.]. These are executed with chord strokes. The key occupancy for these characters can be based on the pocket calculator standard. On panels b-e of FIG. 2D it can be seen which strokes can be selected for which operands. Further blocks: function block [F^{b}], cursor block [F^{b}] and some others.

3.2 New Types of Miniature Keyboards

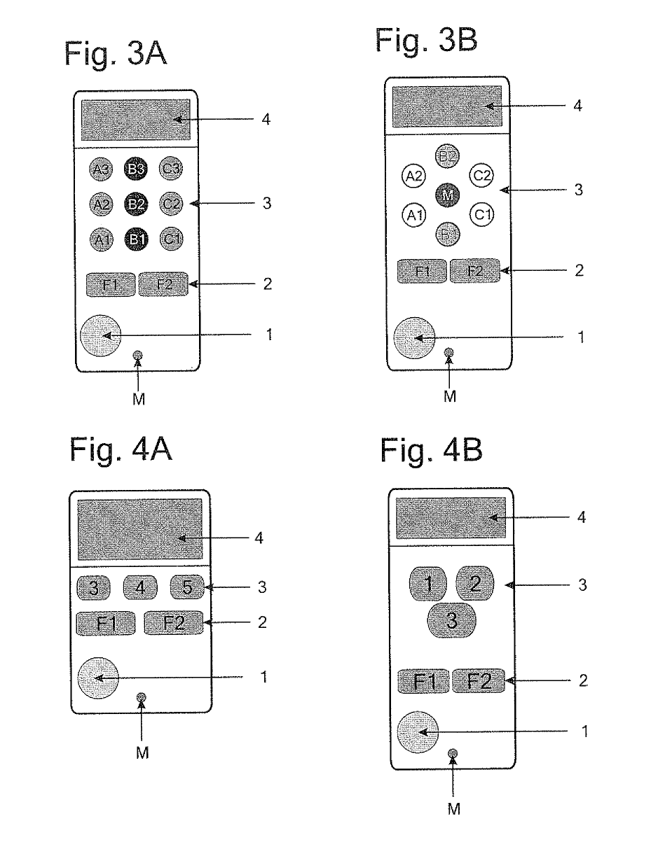

(A) THUMB KEYBOARD WITH NINE KEYS: On the keyboard according to FIG. 3A there are nine keys arranged in three rows and three columns. The keys are arranged in a punctuate manner upwardly inwardly curved (convex) and at a short distance from one another so that they can be hit with the thumb in a chord on a small area. The curvature and different surface conditions facilitate the haptic location of the keys. Twenty five single and chord strokes can be executed on the keys. They are sufficient to input the characters of the shortest character set.

(B) THUMB KEYBOARD WITH SEVEN KEYS: Located on the keyboard according to FIG. 3B are 7 keys in a circular arrangement on which 25 single and chord strokes (as in A1) can be executed with the thumb.

(C) THREE-FINGER KEYBOARD: The keyboard according to FIG. 4A has three horizontally arranged keys which can be struck with the three middle fingers of one hand. Seven characters (without a null stroke) can be input with one stroke and 49 different characters can be input with two strokes.

(D) THUMB KEYBOARD WITH THREE KEYS: the keyboard according to FIG. 4B has three keys arranged in a triangle on which 49 characters (as in B1) can likewise be input with double strokes of the thumb.

(4) Writing and Reading Blind Script

4.1 Tactile Scripts:

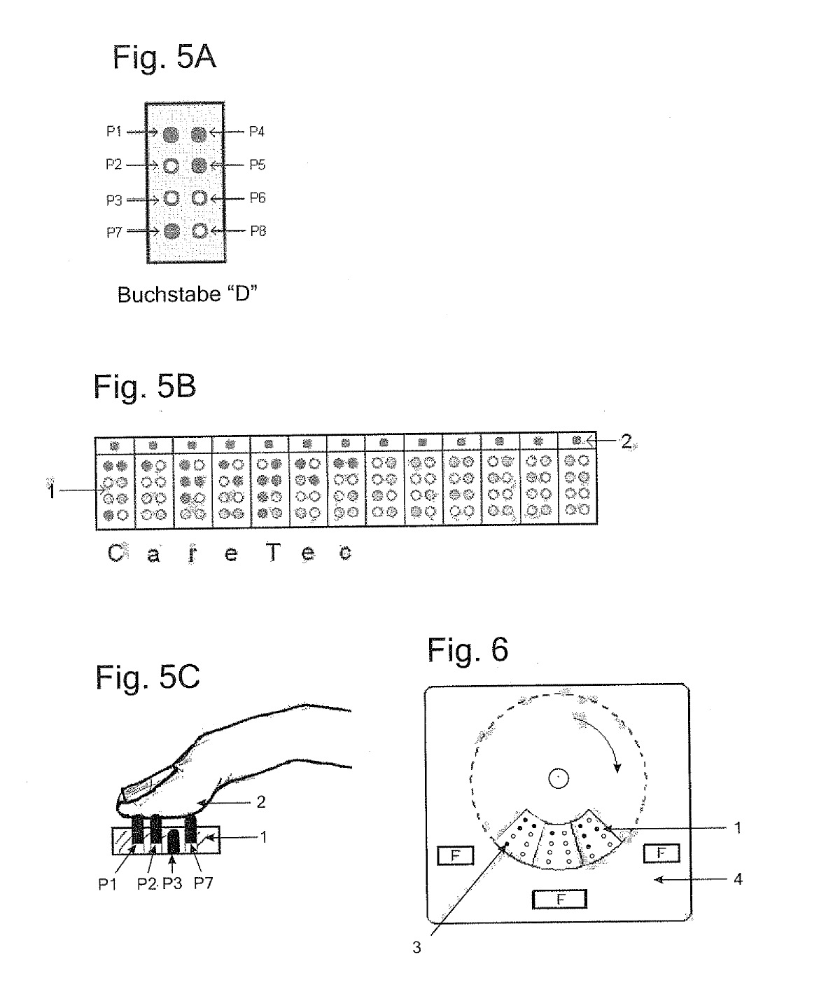

(A) BRAILLE: the script named after its inventor Louis Braille (1809-1852, French, blind) is the only blind script used throughout the world. In this script the characters are represented by semicircular raised dots on paper or other films, on a matrix having 6 or 8 dots so that they can be perceived when stroked by the tip of the index finger (FIG. 5C). The matrix of 6-dot Braille consists of 2 columns and 3 rows on which 64 different characters (63 without null characters) can be represented by single dots or dot combinations. The matrix of 8-dot Braille (FIG. 5A) consists of 2 columns and 3 rows. 256 different characters (255 without null characters) can be represented on this.

The 6-dot matrix is not sufficient to represent the 98 common characters of the German language so that in the case of digits the information sign [#] is used before the letters [a-j] [#a=1; #j=0]. For upper case letters the dot combinations [p3+p6] are used as information signs. Braille is used in German as full script, shorthand, stenography and computer Braille. Braille is represented permanently and temporarily and output on the fly. Permanent Braille is printed with typewriters and printers on special 160 g paper; punches print the raised dots into the underside of the paper, where they are formed hemispherically in the surface by matrices. Modern printers print the elevations double-sided.

Temporary Braille is represented on tactile displays (called Braille displays or Braille lines). A Braille module (FIG. 5A) is provided per character according to the matrix. The Braille lines (FIG. 5B) are formed by arranging modules in a row (FIG. 5B). Longer lines have 80 modules, medium lines have about 40 and small lines have 20 modules and less. The modules have round openings at the interfaces of the matrices in which round pins having a hemispherical tip are raised with piezo-electric elements to represent the character and lowered after the reading process (FIG. 5C). After reading one line, the next is retrieved by pressing a key on the line.

Temporary Braille is output when communicating with deaf-and-blind people, see Point (C) hereinafter. 92% to 93% of all blind people have no access to Braille. This is because the knowledge of the tactile script and the PC which is imparted to those who have gone blind early when they are young can no longer be imparted in most cases to those who have gone blind in later years, who make up the majority of all blind people. This is particularly not possible if they do not have sufficient knowledge of typing.

The most difficult problem however is reading the script. The characters are only recognised by the readers when the stimuli perceived by them agree with the dot combinations which they know. Since the tip of the index finger is small, the dots represented compactly on the matrix frequently can only be poorly identified. Braille reading is therefore four to five times slower than the reading of sighted people. In addition, the long distance which must be covered by the finger during reading is associated with great physical effort.

(B) MOON SCRIPT: the scripted invented by Dr. William Moon (1818-1894) has raised lines, characters are punched in using simple typewriters and Braille printers. There are no displays for Moon. The script is used in English-speaking countries by a restricted number of people.

(C) TEMPORARY SCRIPTS FOR DEAF MUTES: deaf-and-blind people are also users of Braille, where they also communicate hand-to-hand with other people in this script. In this case, the sender presses the Braille characters with his fingers onto the fingers of the receiver as if his fingers were a 6-dot Braille keyboard. The pressure is repeated many times (drummed) so that the characters can be received clearly. In some countries the Lorm system invented by Hieronymus Lorm (1821-1902) is also used for communication with deaf-and-blind people. In this the sender writes the characters with one finger of his hand into the hand of the receiver. Similar temporary scripts also exist in other countries.

4.2 Writing Implements for Blind People

(A) SIMPLE WRITER-PRINTER: Braille is written using simple mechanical and electromechanical writers which are comparable to the mechanical typewriters of the last century. They are fitted with Braille keyboards (FIGS. 1A and 1B).

(B) EFFICIENT WRITING IMPLEMENTS: electronic devices are also available to blind people for text input, even comprising workplace equipments with PC or laptop, speech output, Braille display, Braille printer and other hardware and software. These devices have a full keyboards where what is written in normal script can be converted into Braille. Efficient inputting is also offered by Braille organizers and Braille notebooks having similar equipment but Braille keyboards (FIG. 1A and FIG. 1B). This equipment usually cannot be used by people who go blind in later years.

Our new type of method of mechanical text input (Point 2) is also provided for blind people, severely visually impaired and deaf-and-blind people. The keyboard has the capacity of a small computer (organizer) with which the multimedia connection can be made. The text written in normal text can be converted into tactile text, as in a PC. An additional voice output (text-to-speech) application and a tactile display, for severely visually impaired, a display for upper case representation, is also provided for our keyboard.

4.3 Tactile Outputs

(A) TACTILE PRINTOUTS: the simple Braille writers are also printers at the same time. Upon hitting the keys, the punches mounted on toothed racks are pressed onto the inserted paper. If pressure is continued, the punch presses the paper into the matrix where the raised dots are formed in hemispherical shape. The actual Braille printers are independent devices which exist in various designs. All modern printers can print text double-sided, some of them can even print tactile graphics. The largest of them are operated by institutions for the blind. They are predominantly used for printing out books. There are no actual printers for moon but the moon characters can also be printed out in dotted lines using Braille printers.

(B) Tactile Displays:

B1: CONVENTIONAL BRAILLE LINES (FIG. 5B); efficient writing without using Braille lines is no longer thinkable today since voice output is not sufficient even for qualified writers to be able to create texts in appropriate quality. Braille lines are used in the PC as full lines with 80 modules as half-lines with 40 modules, in laptops usually with 40 modules and in Braille notebooks and Braille organizers with 20 and less modules. Braille lines have given blind people access to the internet and therefore to the information society, and severely reduced the need for Braille printouts. Their importance cannot therefore be assessed highly enough. A disadvantage however is that the displays are relatively large and heavy as well as expensive and, despite the great need, cannot be used by many blind people because of the lack of Braille and PC competence. It is also a disadvantage that even on full lines only a little tactile text, that is about as much as on one of these lines, can be displayed. Since what has been written must be checked frequently, numerous interruptions occur during the writing process which reduces the writing efficiency despite the high writing speed. Last but not least it is disadvantageous that the reading finger and therefore also the hand as well as the underarm must cover a distance of one meter when reading a line so that the reading requires a high physical effort.

B2: NEW TYPE OF CONTINUOUS BRAILLE DISPLAY (FIG. 6): In a new type of continuous display the Braille modules are located on a covered rotating disk. Upon rotating the disk the characters are conveyed into the display region for reading with the finger. The function keys are also used to adjust the rotation speed. The display has the advantage that a large amount of text can be represented on this unrestrictedly and the reading finger does not need to cover large reading distances but can remain stationary. In terms of the principle it is an ideal device for reading out loud in which the texts are output temporarily. It is therefore in competition with the Braille printout.

(C) DISPLAY FOR COMMUNICATING WITH DEAF-AND-BLIND PEOPLE: As stated under Point 4.1C, deaf-blind people also communicate hand-to-hand with other people whereby they press (drum) the Braille characters with their fingers onto the fingers of the receiver as if their finger were a 6-dot Braille keyboard. This principle of the “temporary” output of Braille is also applied in a deaf-blind communication device. This has a 6-dot keyboard on which the characters are written and transmitted electronically to the user. Below the keys are 6 depressions in which vibrating keys are located. The writer grips into these with his fingers in order to receive the reply to his communication (in Braille).

(5) New Types of Dot Scripts

The texts available in normal full text can be converted into Braille as in the PC. In order to make the texts accessible to people who have gone blind in later years, our invention provide new types of dot scripts with fewer tactile characters so that only primary characters are used here.

Example 1: stored text: [Wenn ich einen Computer häte, könnte ich 1000 Gedichte schreiben!]; back translation: [wwenn ich einen ccomputer haette, koennte ich ajjj ggedichte schreiben rufzeichen]. Example 2: stored text: [ich glaube nichtsdestoweniger, dass der Zug heute kommen wird]; back translation [i glaube ndw, ss r zzug heute kommen wird].

A primary character set of 24 tactile characters can store 62% of all characters of 6-dot Braille which facilitates the learning and in particular the identification of the characters because the 24 characters can be represented with fewer dots and on a smaller matrix than in 6-dot Braille.

A1: UNIVERSAL DOT SCRIPT (FIG. 11A): a fundamental weakness of Braille is that the dot combinations are subordinate to the alphabet. This is disadvantageous since there is no universal alphabet, even in the Latin letters there are language related differences. Our universal dot script follows the binary arrangement on a perfect matrix (16×16).

A2: DOT SCRIPT WITH HORIZONTAL 6-DOT MATRIX (FIG. 11B): this matrix has 3 columns and 2 rows. 64 different dot combinations can be represented on this (63 without null representation). In order to facilitate the reading of the script, we, however, only take into account those combinations which have at least one dot in each column. As a result, the boundaries between the characters are better identifiable. In Braille this is not always the case because there are characters which have no dots in one of the two columns. 27 characters satisfy the requirement. They can be divided into three groups of 9 characters. The dot combinations in the second and third column are identical in these groups so that learning these characters is easy. Finally the characters in the first column differ. When reading the first column, however, it is already identifiable in which of the three groups the respective character is located. A quite substantial further advantage consists in that two-row characters can be identified more easily than three-row ones.

A3: DOT SCRIPT WITH VERTICAL 6-DOT MATRIX (FIG. 11C): this version is largely conformant with (FIG. 11A) but the matrix is arranged vertically (like the matrix of 6-dot Braille). Here also there is the advantage over Braille that at least one dot is located in each column and a simpler system exists.

A4: DOT SCRIPT WITH 4-DOT MATRIX (FIG. 11D): this version has a perfect matrix with two columns and two rows. On this 16 dot combinations can be presented in an easily legible manner. It is suitable for representing alphabetical, numeric and alphanumeric codes. A primary character set of so few characters is possible in principle if use is made of several information signs (see Point 4.1).

(6) New Types of Tactile Outputs

The reading of Braille is an active process which imposes intellectual and physical requirements on the user. The reading on the continuous display however facilitates the physical effort since the fingers remain stationary during reading. The temporary Braille output on the deaf blind communication device (see Point 4.3C) uses the dot script but has no possibilities for expanding the principle. Our invention is concerned with this.

(A) DOT SCRIPT VERSUS TEMPORARY OUTPUT: the dots of the dot script are uniform so that their stimuli are also perceived uniformly. The temporarily output stimuli of the deaf mute communication device are also uniform so that in this case the communication of information is also determined by the haptic perception capability of the user. However this varies from person to person and diminishes with increasing age.

(B) CONCEPTIONAL VISION: the continuous display and deaf-blind communication device demonstrate that it is possible to bring the stimuli to the users to ease the physical effort of reading. From the principle of the deaf-blind communication devices it can also be deduced that the stimuli can also be guided to other parts of the body and output to these according to the user. In addition, that it must be possible to intelligently equip the stimulus body to increase the information content of the imparted characters and texts.

(C) STIMULUS CONCEPT: our visionary output of temporary tactile information provides stimulus modules comparable with the modules of the Braille display. Located on these are one or more stimulus elements which move the stimulus bodies. The stimulus bodies are comparable to the pins in a Braille display. Our stimulus bodies can also be pins, bolts, wheels, pincers and any other objects. The stimulus bodies execute the stimuli with pressure, vibration, friction, impact, scratching or any other movements. It is unknown whether stimuli can also be exerted with electricity (possibly even subcutaneously), with air pressure or temperature. Should such possibilities be indicated, they are also part of our invention and they satisfy the claims of said invention. The stimuli are predominantly exerted with a plurality of partial stimuli to intensify the stimulus effect. They can also be deflected to any stimulus positions of the body. It is also important that the communication of the stimulus can be more extensive than in Braille and also that the stimuli can take place at short intervals at different points within the respective stimulus position in order to prevent the sensitivity of the local nerves or nerve fibres from being impaired on account of overloading.

Our invention also provides parameter settings for the stimuli which can be related to the speed and intensity of the stimuli and partial stimuli, the number of partial stimuli of which the stimulus is composed, the intervals between the partial stimuli, the length of the partial stimuli, the direction of the partial stimuli and the like.

(D) SIMPLE STIMULUS DIFFERENTIATION: in this a distinction is made, for example between short and longer stimuli so that a longer stimulus of the [o] could communicate a [ö], a longer stimulus of the [s] could communicate a [β] and a longer stimulus of the [a] could communicate an [ä].

(E) MULTI-DIMENSIONAL STIMULUS DIFFERENTIATION: in this, intelligent stimulus elements are used so that the information content of each individual character, word or text can be varied with differentiations of stimulus.

Examples: in the conventional Braille shorthand an [a] can have several meanings in the context so that it is incumbent upon the user to make the connection to the correct word with his knowledge of the shorthand. This knowledge is not necessary if the user knows the rules of stimulus differentiation. For example, the field of topics “geography” could have a special stimulus characteristic so that [s] means a city and [l] means a country. Consequently, [sy] could communicate the city New York and [la] could communicate the country Austria.

The principle of the multi-dimensionality of information which is achieved with stimulus differentiations goes far beyond the Braille shorthand already used now by the blind person. It is also not inferior compared with the one-dimensional text representation of the sighted person. The opinion that the reading of the blind person cannot be fast since blind people are not able to grasp whole words or text portions predictively (like the sighted person) accordingly cannot be upheld.

(F) SUBSTITUTE ELEMENTS: instead of stimuli, substitute elements can also be used to differentiate words and texts. These can be communicated by other hardware part. For example, with a “buzzing or beep sound” of a loudspeaker.

(G) DISPLAYS FOR RECEIVING TEMPORARY TACTILE TEXTS: the displays for receiving temporary tactile texts are either configured to be concave or convex. In the case of concave displays the modules with their stimulus bodies are located in depressions, in the case of convex displays they are located in elevated positions in order to be able to be reached more easily by the extremities of the reader. The stimuli are output more extensively than in Braille.

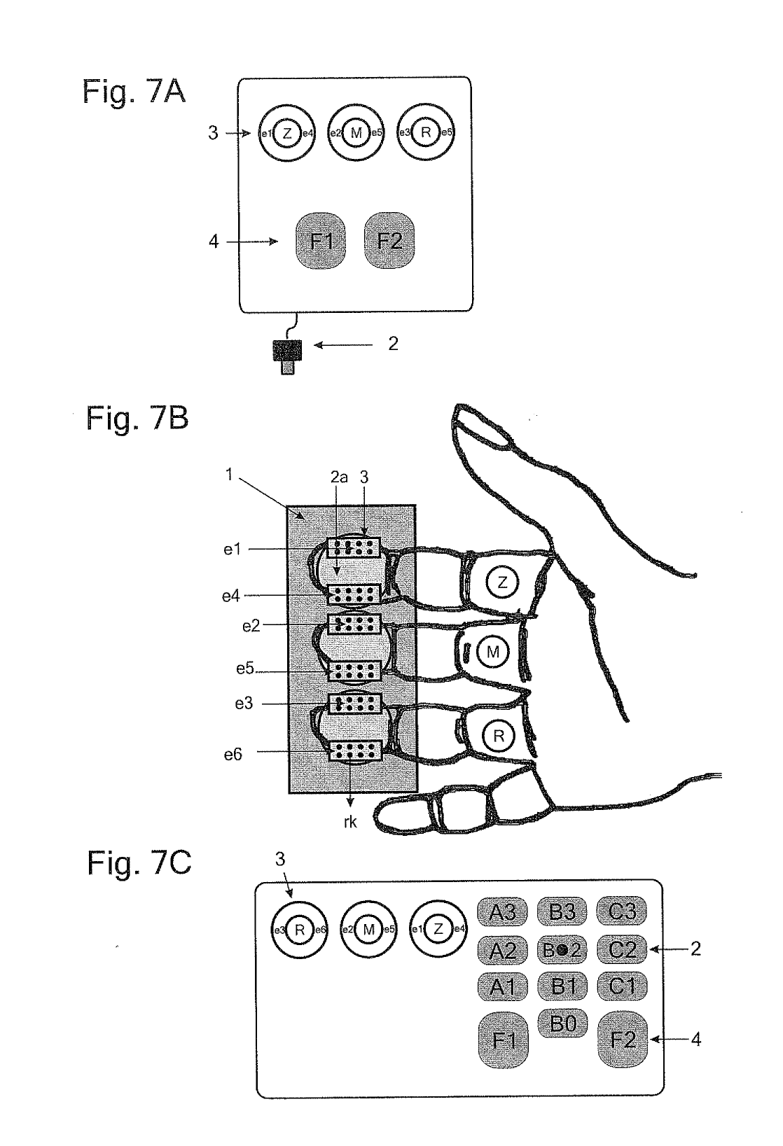

G1: STAND-ALONE DISPLAYS (FIG. 7A): this is a portable display which can be connected to any measuring, weighing and computing units and also, for example, to cash machines.

G2: INTEGRATED DISPLAYS (FIG. 7C): these displays are permanently connected to organisers and any other devices.

G3: DISPLAYS PERMANENTLY ASSOCIATED WITH THE USER (FIG. 9): for reading longer texts, for continuously checking written texts and for longer communication with other persons, displays are provided on finger stalls, gloves, sleeves, belts or any other apparatus. They are permanently connected to the receiving points of the reader.

The present invention is explained in detail hereinafter:

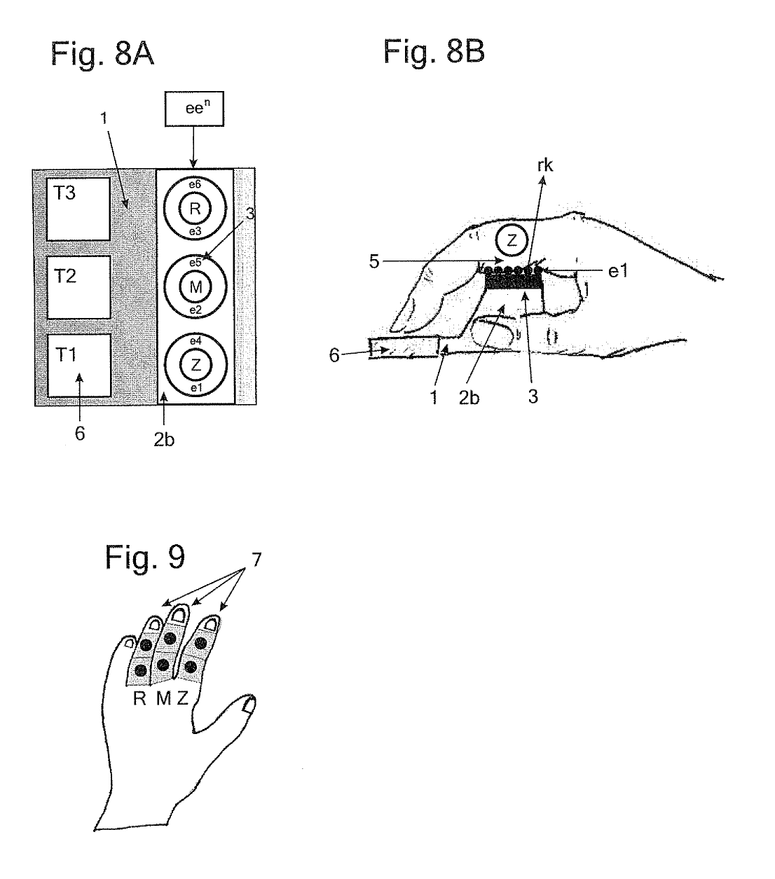

FIG. 1A shows an 8-dot Braille keyboard, FIG. 1B shows a 6-dot Braille keyboard, FIG. 1C shows a 6-dot Braille keyboard as used by deaf-blind people for communicating, FIG. 2A shows the real upper keyboard level of the one-handed keyboard of our invention, FIG. 2B shows the computing block of our one-handed keyboard, FIG. 2C shows the block structure of the one-handed keyboard with its virtual keyboard levels, FIG. 2D shows on tables a-j 31 the strokes which can be executed simply on the ten-key keyboard, FIG. 3A shows a thumb keyboard with 9 keys, FIG. 3B shows a thumb keyboard with 7 keys, FIG. 4A shows a keyboard with three horizontal keys, FIG. 4B shows a thumb keyboard with triangularly arranged keys, FIG. 5A shows the 8-dot Braille matrix, FIG. 5B shows a conventional Braille matrix with Braille modules arranged in a row, FIG. 5C shows a Braille module in cross-section, FIG. 6 shows a new type of continuous display, FIG. 7A shows a concave display for receiving temporary tactile characters, FIG. 7B shows a concave display for receiving temporary tactile characters from the underside of the display, FIG. 7C shows a concave display for receiving temporary tactile characters as an integrated part of an organiser with one-handed keyboard, FIG. 8A shows a convex display for receiving temporary tactile characters, FIG. 8B shows the position of the finger above the display (FIG. 8A), FIG. 9 shows a display consisting of three finger stalls which are permanently connected to the hand, FIG. 10A shows the structure and matrix of the new type of universal dot script, FIG. 10B shows the structure and matrix of a new type of horizontally arranged 6-dot matrix, FIG. 10C shows the structure and matrix of a new type of vertically arranged 6-dot matrix, FIG. 10D shows the structure and matrix of a 4-dot matrix arranged in a square.

FIG. 1A shows an 8-dot Braille keyboard having 8 character keys (2) and two function keys (4). In the base position the index finger, ring finger, middle finger and the small fingers of both hands rest on the keys designed by “Z, M, R and K”, the thumbs on the “D” keys. With a single or chord stroke on these keys, [P1-P8] are input as Braille dots.

FIG. 1B shows a 6-dot Braille keyboard with 6 character keys and two function keys (4). Other details are as FIG. 1A as appropriate.

FIG. 1C shows a 6-dot Braille keyboard as in FIG. 1B. However this is equipped with an additional concave display with 6 depressions (3). Located in each depression is a module with a stimulus element (e1-e6). In order to receive temporary tactile characters the recipient places the tips of his fingers into the depressions. If, for example, only the stimulus (e1) is communicated, which corresponds to the Braille dot P1, the received characteristic is an [a].

FIG. 2A shows the real upper keyboard level [RO] of the one-handed keyboard of our invention. This has the form of a ten-key keyboard. The 9 keys A1 to C3 are the central character keys (3). They are struck individually or in a chord. The 31 easily executable strokes on these keys can be seen in tables a-j of FIG. 2D. The character keys also include the key B0. The primary characters consisting of the most frequently used lower case letters and some punctuation marks are input on the 10 keys. All other characters are input on these keys. This also includes those of the virtual keyboard levels which are retrieved for this purpose with pre- or post strokes. The F1 and F2 keys are control keys. (1) shows the loudspeaker, (4) the visual display, (M) the built-in microphone. See further details in the text part of the invention.

FIG. 2B shows the computing block [R^{b}] of the keyboard which located conceptually below the real upper keyboard level [RO]. On this the 10 digits can be input with a single stroke and several operands [such as +,-,/.*] can be input with a chord stroke. The chord strokes which can be used to input the operands can be seen from Table b-e of FIG. 2D. The computing block can, in executing its function as a pocket calculator, be selected permanently. Its characters can, however also be selected with alternative strokes on the fly. See further details in the text section.

FIG. 2C shows the block structure of the keyboard with its virtual keyboard levels. Further details are found in the text section.

FIG. 2D shows in tables a to j all 31 strokes on the central character keys A1 to C3 (of the keyboard according to FIG. 2A) which can be executed simply.

FIG. 3A show a thumb keyboard with 9 punctuate character keys which are arranged upwardly curved (convex) and at a short distance from one another (2), function keys (2), loudspeaker (1), microphone (M), visual display (4). On the keyboard 25 characters can be input with single or chord strokes of the thumb. Further details in text part.

FIG. 3B shows another thumb keyboard with 7 character keys (3), two function keys (2), loudspeaker (1), microphone (M) and visual display (4). On the keyboard 25 characters can be input with single or chord strokes of the thumb. Further details in text part.

FIG. 4A shows a three-finger keyboard with three horizontally arranged keys (3), two function keys (2), loudspeaker (1), microphone (M) and visual display (4). On the keyboard 49 single or chord strokes can be executed with a double stroke of the three middle fingers of one hand.

FIG. 4B shows a thumb keyboard with triangularly arranged keys on which 49 strokes can be executed with a double stroke of the thumb.

FIG. 5A shows the 8-dot Braille matrix with the dot designations P1 to P8. The dots P1, P4, P5 and P7 shown in black are raised dots which form the upper case letter “D”.

FIG. 5B shows a conventional Braille line consisting of Braille modules (1) arranged in a row. The dots shown black are raised dots which form the name CareTec. A strip with cursor keys is located above the module. On pressing a key, the cursor jumps into the position of the respective line.

FIG. 5C shows the first column of a Braille module (1). This representation can be seen under (3) in FIG. 6. The finger recognises the dots shown raised P1, P2 and P7 but not the lowered dot P3.

FIG. 6 shows the tactile continuous display in which the modules (1) are located on a covered rotating disk. During rotation of the disk the module enter into the open display region where they can be read with the stationary finger. On this display the reading finger can stay stationary. Point (4) shows the function keys with which the rotational speed of the disk can be controlled.

FIG. 7A shows a “concave” display for receiving temporary tactile characters with the right hand. Index, middle and ring finger grip into the depressions (3). In the depressions the modules are equipped with respectively two stimulus elements [e1-e4] [e2-e5] [e3-e6] so that two stimuli are received per finger. The reception of the stimulus is therefore more extensive than in Braille. It is a “stand-alone display” that can be connected to any device. It has two function keys (4).

FIG. 7B shows a “concave” display (1) for receiving temporary tactile characters with the right hand. The sketch shows the display (1) from its underside. It has three modules (3) located in depressions (2a). The fingers Z, M, R grip into these for receiving tactile characters (stimuli). Two stimulus elements [e1-e4] [e2-e5] [e3-e6] are located on each module 3 so that two stimuli can be received per finger. A stimulus is composed of several partial stimuli. The partial stimuli are produced by individual stimulus bodies [rk] where a random generator decides which stimulus body is activated. This prevents individual nerves or nerve fibres from losing sensitivity on account of being triggered too frequently.

FIG. 7C shows a “concave” display for the left hand as an integrated part of an organiser with one-handed keyboard. See FIG. 7A and FIG. 2A.

FIG. 8A shows as an example a “convex” display for receiving temporary tactile characters. In this three modules (3) with their stimulus elements [e1-e4] [e2-e5] [e3-e6] are located on a small rise (2b) so that only short finger paths are required to receive the stimuli. In this version (as all others hitherto not specially cited), use can also be made of substitute elements (ee′) (see text part). The display can form a unit with the keys (T1-T3) of the respective keyboard, as is also the case with the one-handed keyboard of our invention.

FIG. 8B shows the index finger (Z) of the right hand on a “convex” display (1). The third segment of the index finger rests (5) on the module (3) located on the rise (2b). The stimulus element (e1) is located on the left side of the finger whilst that on the right (e4) cannot be seen on the sketch. The keys of the keyboard (6) are located in touching proximity to the fingers.

FIG. 9 shows a display consisting of three finger stalls (7) which are permanently connected to the index finger (Z), middle finger (M) and ring finger (R) of the left hand. Located on each of the three finger stalls are two modules having respectively one stimulus element which can be located at arbitrary positions of the finger (front side, rear side, and at the side). Displays such as these can also be located at any other body positions.

FIG. 10A shows the structure and matrix of the new type of tactile universal dot script according to the text explanations.

FIG. 10B shows the structure and matrix of the new type of tactile 6-dot horizontal script according to the text explanations.

FIG. 10C shows the structure and matrix of the new type of tactile 6-dot vertical script according to the text explanations.

FIG. 10D shows the structure and matrix of the new type of tactile 4-dot script arranged in a square according to the text explanations.

The various ideas set out here can be summarised as follows:

Principle of separation between primary and secondary characters:

The use of both hands in typing is not desirable for health reasons. There are many discourses on this. In addition it ties up both hands and the two-handed keyboard takes up a large amount of space. It is therefore a question of one-handed input in which the physiological and intellectual requirements of the person should be noted and not the number of characters required. The solution with the one-handed input also shows that the two-handed keyboard can be dispensed with, which has corresponding advantages.

Substitute inputs are also possible for retrieving information, executing the text processing functions, accessing icons of the screen, operating the keyboard and its peripheral units, i.e. as a replacement for computer mouse and the cursor keys. This enables fewer interruptions of the writing rhythm, easy learning of key operation.

Further possibilities in this connection are:

Acoustic support of the input: retrieving programs, in particular in multimedia devices.

Help function: enquire how a character or a text can be input.

Alternative inputs: equally efficient as strokes on the upper keyboard level.

Principle of the large text file: in the case of congruence with a stored unit, the respective action: input of characters and text and also execution of the above actions (1) is triggered.

Identifications of the substitute inputs:

(A) Post-strokes which are also accompanied by an automatic space: the inputs are given different information with differentiated strokes.

See example: [sy] for city “New York” with the temporary output of tactile text=multi-dimensional input which could go in the direction of automatic sign language???

(B) Identification with rare characters [q, x, y] or with all three characters for different purposes; see differentiation as (A).

New type of mobile phone keyboards:

(A) Single stroke using a keyboard with dot-shaped keys.

(B) Double stroke using only three keys. The keyboard can not only be smaller than the mobile phone but requires fewer strokes than the mobile phone.

(C) 6-dot Braille can also be input one-handed with (B) which had escaped me when writing the application. This could be added in FIG. 4A and FIG. 4B. Even 8-dot Braille can be input with a small addition. There is no efficient one-handed keyboard for Braille.

The reading of 6-dot Braille can be improved significantly with the horizontal 6-dot matrix (FIG. 10B) because two rows are easier to read than three. With three rows, vertical movements of the finger are frequently required which are not necessary with two rows.

With the temporary output, texts of any length can in fact be output, where only a few fingers (3) are required to identify this. Only 6 actuators (stimulus elements) are therefore required instead of 640 in the case of a full line. The display can therefore be very small. It has space on the input device (organizer) and should therefore be very cheap to manufacture.

1. A method for inputting data through a keyboard to whose keys individual characters of a character set are assigned, wherein the number of keys is less than the number of characters of the character set wherein sequences of key strokes corresponding to sequences of characters which are impossible or improbable in the context of the data to be input, are used for encoding characters or character sequences that are not assigned to a key.

2. The method according to claim 1, wherein at least one key is assigned to a punctuation mark and is used at the same time in conjunction with characters assigned to other individual keys for the encoding of characters not assigned to keys.

3. The method according to claim 1, wherein individual characters are input by chord strokes of several keys.

4. The method according to claim 1, wherein individual characters are input by means of a character sequence which phonetically corresponds, for example, to the designation of the respective character.

5. The method according to claim 1, wherein individual characters are input by switching into alternative keyboard levels in which the individual keys or key combinations are each assigned different characters.

6. The method according to claim 1, wherein individual characters are input by special strokes.

7. The method according to claim 1, wherein most frequently occurring characters are directly assigned to the keys.

8. The method according to claim 1, wherein individual characters or character combinations are input to represent more frequent words or word combinations.

9. A method for outputting data via a display, a printout or via temporary stimuli, through symbols which are assigned to individual characters of a character set, wherein the number of symbols is less than the number of characters of the character set wherein sequences of symbols corresponding to sequences of characters which are impossible or improbable in the context of the data to be input, are used for encoding characters or character sequences that are not assigned to a symbol.

10. (canceled)

11. An apparatus for inputting data comprising a keyboard having a plurality of keys which are assigned to individual characters of a character set, wherein the number of keys is less than the number of characters of the character set wherein sequences of key strokes corresponding to sequences of characters which are impossible or improbable in the context of the data to be input, are assigned to further characters or character sequences that are not assigned to a key.

12. The apparatus according to claim 11, wherein at least one key is assigned to a punctuation mark and at the same time, in conjunction with other keys, encodes characters which are not assigned to individual keys.

13. The apparatus according to claim 11, wherein individual characters are assigned to a combination of several keys which are struck simultaneously.

14. The apparatus according to claim 11, wherein the keys are arranged in a substantially rectangular arrangement in rows and columns which are configured for operation with a single hand of the user and that the keys are arranged in three columns assigned to the index finger, the middle finger and the ring finger and that furthermore the characters to be input are assigned to individual keys or a combination of several keys of different columns.

15. The apparatus according to claim 14, wherein the characters to be input are assigned to individual keys or a combination of several keys of different columns of the same line.

16. The apparatus according to claim 11, wherein individual characters are assigned to a sequence of several keys which correspond, for example, phonetically to the designation of the respective character.

17. The apparatus according to claim 11, wherein a plurality of keyboard levels are provided, in which respectively different characters are assigned to the individual keys or key combinations.

18. The apparatus according to claim 11, wherein individual characters are assigned to keys or key combinations which are hit by special strokes.

19. The apparatus according to claim 11, wherein the most frequently occurring characters are assigned directly to the keys.

20. The apparatus according to claim 11, wherein a further input device is provided which has a plurality of successively arranged input regions which correspond to a plurality of successively input groups of characters.

21. The apparatus according to claim 20, wherein the groups of characters represent words or numbers.

22. The apparatus according to claim 20, wherein the groups of characters represent paragraphs.

23. The apparatus according to claim 22, including a display device which is configured to display Braille characters.

24. The apparatus according to claim 11, including a display device is provided, which is configured to display a shortened dot script.

25. The apparatus according to claim 24, wherein the shortened dot script represents a part of the characters of the character set directly by dot arrangements and another part by combinations of dot arrangements which comprise a dot arrangement encoding a punctuation mark.

26. The apparatus according to claim 25, wherein the input regions are configured as fields on a touch screen.

27. The apparatus according to claim 26, wherein the fields of the touch screen are marked so that they can be detected in a tactile manner.

28. The apparatus according to claim 11, including a speech output device which is configured to output the group of characters addressed by actuating an input region.

29. An apparatus for outputting data comprising a device for creating a display, a printout or temporary stimuli, wherein the data are characterized by symbols which are assigned to individual characters of a character set, wherein the number of symbols is less than the number of characters of the character set wherein sequences of symbols corresponding to sequences of characters which are impossible or improbable in the context of the data to be input, are used for encoding characters or character sequences that are not assigned to a symbol.

30. (canceled)

31. A method for outputting data in which characters are represented by exciting different skin regions of a user, wherein a plurality of excitation modes which are used alternately are assigned to each skin region.

32. The method according to claim 31, wherein the excitation modes of one skin region are synonymous.

33. The method according to claim 31, wherein the excitation modes are formed by spatially adjacently located excitation points.

34. The method according to claim 31, wherein the excitation modes are formed by vibrations of different frequency.
